(19) United States
(12) Patent Application Publication
(10) Pub. No.: US 2019/0126837 A1
(43) Pub. Date: May 2, 2019

(54) SYSTEM FOR COVERING A MOTOR-VEHICLE LUGGAGE COMPARTMENT

(71) Applicant: TREVES PRODUCTS, SERVICES & INNOVATION, Paris (FR)

(72) Inventors: Alicia Lecomte, Villers-Franqueux (FR); Jean-Yves Airault, Concoret (FR)

(21) Appl. No.: 16/093,722

(22) PCT Filed: Apr. 4, 2017
(86) PCT No.: PCT/FR2017/050792

§ 371 Date: Oct. 15, 2018

(30) Foreign Application Priority Data
Apr. 15, 2016 (FR) 1653363

(51) Int. Cl. B60R 5/04

(52) U.S. Cl. CPC B60R 5/048

(57) ABSTRACT

The invention relates to a system for covering a motor-vehicle luggage compartment having two lateral supports a front panel pivotably connected to the supports, a rear panel pivotably connected to the supports about a second transverse shaft, and a hinge being a third transverse single rotation shaft. Each end of the second shaft is slidably guided along two guide rails (10) mounted on each of the supports. The rear end of each of the rails positioned such that, when the panels are in the position in which they cover the compartment, a forward force exerted on the second shaft rotates the panels so that they move into the position in which they provide access to the compartment.

### CROSS-REFERENCE TO RELATED APPLICATION

This application claims the benefit of International application number PCT/FR2017/050792, filed Apr. 4, 2017 and French patent application number 1653363, filed on Apr. 15, 2016, the entire contents of which are incorporated herein by reference.

### TECHNICAL FIELD

The invention relates to a system for covering a motor-vehicle luggage compartment.

### BACKGROUND

Producing a system for covering a motor-vehicle luggage compartment is known, the system comprising:
two lateral supports,
a front flap articulated in relation to the supports on a first transverse axis extending along the front edge of the flap,
a rear flap articulated in relation to the supports on a second transverse axis, the second axis being mounted so as to slide longitudinally with respect to the supports,
a hinge connecting the rear edge of the front flap to the front edge of the rear flap, the hinge defining a single third transverse rotation axis and being arranged so as to allow a rotation of the flaps upwards, in order to pass them from a covering configuration, in which they are horizontally in line with one another, to a configuration for access to the compartment, in which they are folded one towards the other.

It should be noted here that the fact that the hinge defines a single rotation axis makes it possible to guarantee the absence of any vertical movement between the flaps in the covering configuration when the vehicle is travelling, such movements being able to give rise to unwanted noise causing acoustic discomfort for the passengers.

There exist in fact embodiments, such as for example the one proposed in the document FR 3019119 A1, wherein the hinge is formed by a flexible band allowing vertical movement of the flaps in respect to one another when they are in the covering configuration, which may cause the abovementioned problem.

With an arrangement in which the third rotation axis is single, the problem of being able to pass the flaps simply and reliably from their covering configuration to their access configuration is however posed, in particular when the flaps are actuated by an actuation device comprising in particular a drive means.

### SUMMARY OF THE INVENTION

The aim of the invention is to propose an arrangement for achieving this objective.

To this end, the invention proposes a system for covering a motor-vehicle luggage compartment, the system comprising:
two lateral supports,
a front flap articulated in relation to the supports on a first transverse axis extending along the front edge of the flap,
a rear flap articulated in relation to the supports on a second transverse axis, the second axis being mounted so as to slide longitudinally with respect to the supports,
a hinge connecting the rear edge of the front flap to the front edge of the rear flap, the hinge defining a single third transverse rotation axis and being arranged so as to allow a rotation of the flaps upwards, in order to pass them from a covering configuration, in which they are horizontally in line with one another, to a configuration for access to the compartment, in which they are folded one towards the other,
   the system further having the following features:
each end of the second axis is slidably guided by two respective guide rails mounted on each of the supports, the rails extending longitudinally,
the rear end of each of the rails is disposed so that, when the flaps are in the covering configuration and observed in side view, the lower angle defined by a first straight line connecting the second and third axes and by a second straight line connecting the first and third axes is less than 180°, so that a force exerted forwards on the second axis effects a rotation of the flaps in order to pass them into the access configuration.

In this description, the terms for positioning in space (top, recto, verso, longitudinal, transverse, lateral, front, rear, horizontal, lower, etc.) are taken with reference to the system in place in the vehicle, the flaps being in the covering configuration.

The fact that the aforementioned straight lines form an angle as defined makes it possible to initiate the rotation of the flaps when they are in their covering configuration by simple application of a forward force on the second axis, the force giving rise to a torque allowing the expected rotation.

It goes without saying that the force to be applied for initiating the rotation will be lower, the more the angle moves away from 180°.

### BRIEF DESCRIPTION OF THE DRAWINGS

Other particularities and advantages of the invention will emerge from the following description given with reference to the accompanying drawings, in which:

FIG. 1 is a schematic view in partial perspective of a system according to one embodiment, the flaps being in the covering configuration,

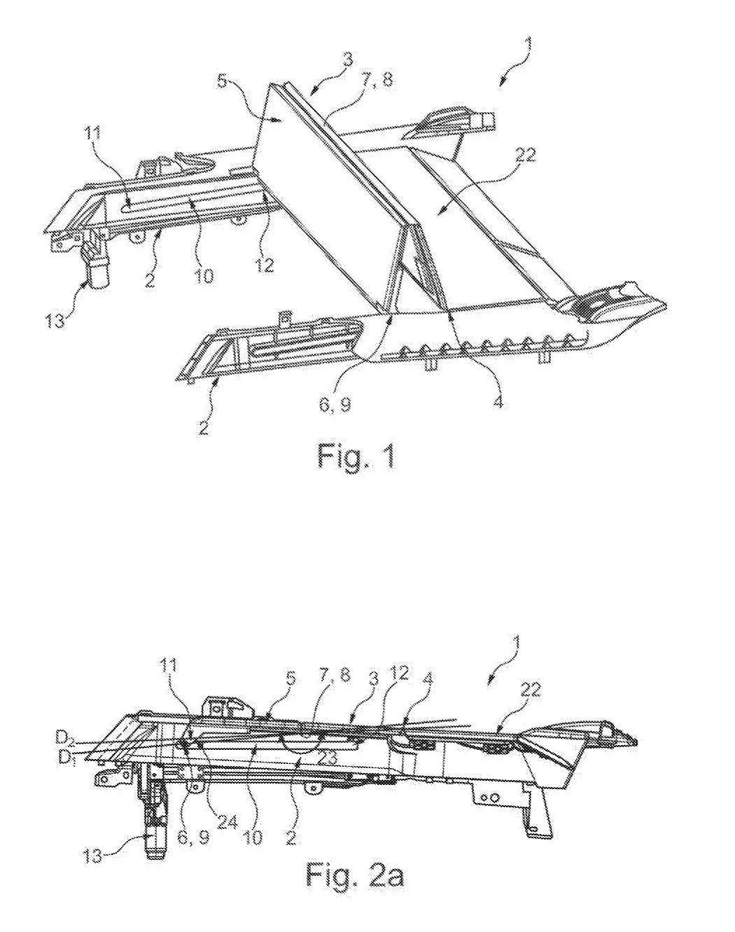

FIGS. 2a, 2b and 2c are a schematic representation in side view of the system in FIG. 1, the flaps being in the covering configuration (2a), the access configuration (2b) and the enlarged access configuration (2c),

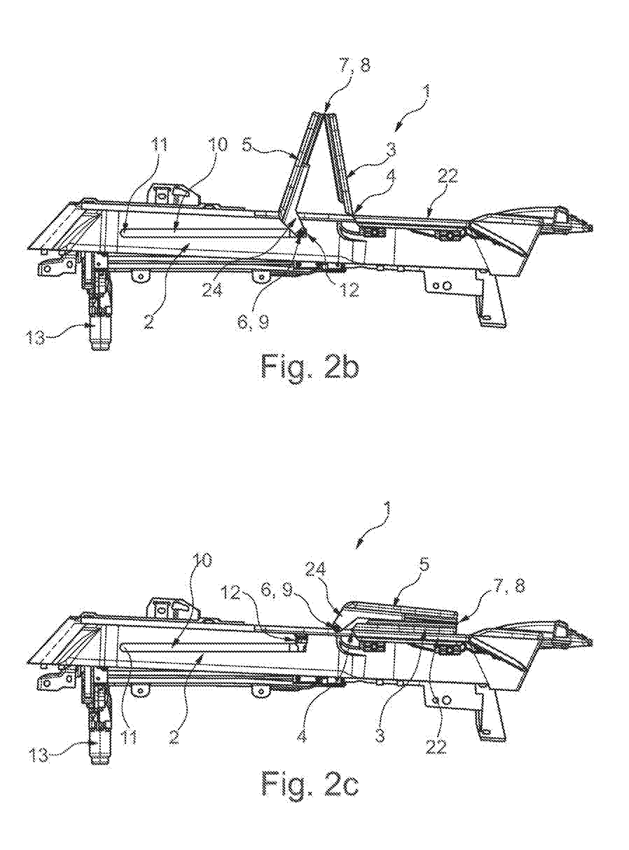

FIGS. 3a and 3b are detail views in partial perspective of the system in FIG. 1, FIG. 3a including a flexible band and FIG. 3b having none so as to display the worm.

### DETAILED DESCRIPTION

With reference to the Figures, a system 1 for covering a motor-vehicle luggage compartment is described, the system comprising:
two lateral supports 2,
a front flap 3 articulated in relation to the supports on a first transverse axis 4 extending along the front edge of the flap,
a rear flap 5 articulated in relation to the supports on a second transverse axis 6
disposed here at the middle part of the flap—, the second axis being mounted so as to slide longitudinally with respect to the supports,
a hinge 7 connecting the rear edge of the front flap to the front edge of the rear flap, the hinge defining a single third transverse rotation axis 8 and being arranged so as to allow a rotation of the flaps upwards, in order to pass them from a covering configuration, in which they are horizontally in line with one another, to a configuration for access to the compartment, in which they are folded one towards the other,
   the system further having the following features:
each end 9 of the second axis is slidably guided by two respective guide rails 10 mounted on each of the supports, the rails extending longitudinally,
the rear end 11 of each of the rails is disposed so that, when the flaps are in the covering configuration and observed in side view, the lower angle 23 defined by a first straight line D1 connecting the second and third axes and by a second straight line D2 connecting the first and third axes is less than 180°, so that a force exerted forwards on the second axis effects a rotation of the flaps in order to pass them into the access configuration.

In particular, the lower angle 23 is greater than 170°, in particular around 175° and, in the embodiment shown, approximately 179°, which suffices to allow initiation of rotation of the flaps 3, 5 in the covering configuration.

According to the embodiment shown, the rear flap 5 comprises a lower projection 24 making it possible to effect a lowering of the second axis 6 in order to obtain a lower angle 23 of less than 180°.

According to the embodiment shown, the access configuration corresponds to a raising of the flaps 3, 5 by approximately 90° with respect to their position in the covering configuration.

According to the embodiment shown, the ends 9 of the second axis 6 form laterally projecting fingers, the rails 10 being in the form of slots for receiving the fingers slidably.

According to the embodiment shown, the front end 12 of the rails is open so as to allow a removal of the ends 9 of the second axis 6 from the rails and a folding of the front flap 3 by a half turn in order to benefit from an enlarged access configuration.

According to the embodiment shown, the system 1 further comprises a device for actuating the second axis 6 slidably, the device comprising a drive means 13 mounted on a support 2.

According to one embodiment, only one support 2 is provided with a drive means 13.

According to the embodiment shown, the actuation device further comprises a carriage 14 mounted so as to be able to slide longitudinally on the support 2, one end 9 of the second axis 6 being mounted—here rotatably on the axis—on the carriage, the drive means 13 being mounted so as to actuate the carriage slidably.

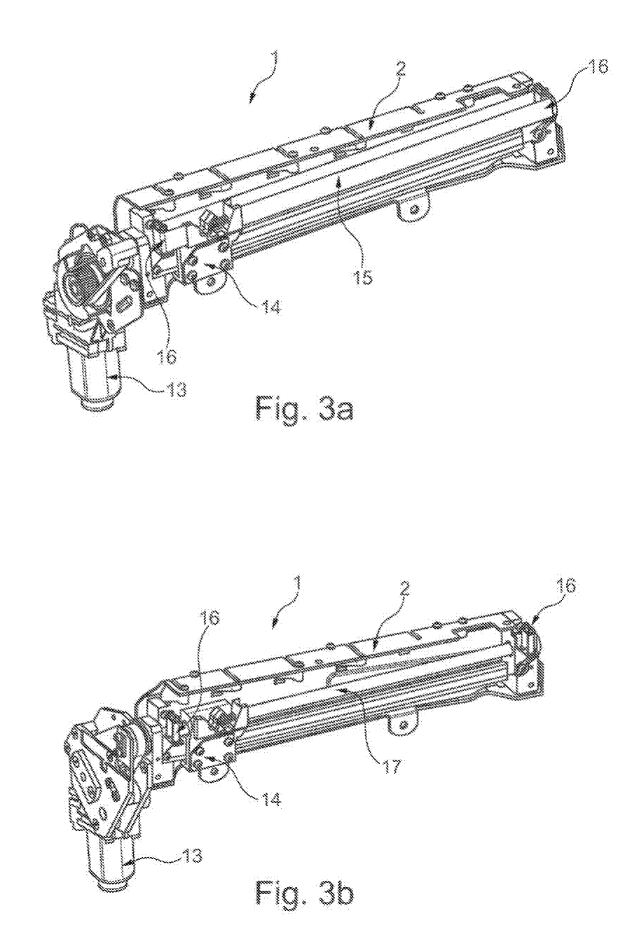

According to the embodiment shown in FIGS. 3a, 3b, the rails 10 are in the form of slots and the carriage 14 is secured to a flexible band 15 closing on itself so as to form a loop mounted in tension around two rollers 16, the rollers being mounted for rotation at the ends of the rail 10, so that the band effects a masking at the rear of the slot.

The actuation device further comprises a worm 17 extending longitudinally, the worm being mounted rotatably on the support 2, the worm passing through a threaded orifice produced in the carriage 14 so as to enable it to be moved when it is actuated for rotation, the rotation being performed by the drive means 13.

According to the embodiment shown, one end 9 of the second axis 6 mounted on a carriage 14 is mounted removably, here by snapping in. Such an arrangement makes it possible to remove the flaps 3, 5 from the supports 2 and/or allows folding of the front flap 3 by a half turn.

In a way that is not shown, the lower faces of the flaps 3, 5 are covered with a verso covering layer, the hinge 7 comprising the portion of the layer extending between the flaps, so as to form a flexible hinge.

Naturally, the portion of verso covering layer must have a negligible width for the third axis 8 to be single, in order to prevent any vertical movement between the flaps 3, 5 in the covering configuration when the vehicle is travelling. In a way that is not shown, the upper faces of the flaps 3, 5 are covered with a recto covering layer also extending over the edges of the flaps, the hinge 7 further comprising the portion of the layer extending between the flaps.

According to the embodiment shown, the system 1 further comprises a fixed panel 22 mounted at the front of the front flap 3, the flap being mounted for rotation at its front edge on the rear edge of the panel so as to be articulated in relation to the supports 2.

What is claimed is:

1. A system for covering a motor-vehicle luggage compartment, the system comprising:
two lateral supports,
a front flap articulated in relation to the supports on a first transverse axis extending along the front edge of the flap,
a rear flap articulated in relation to the supports on a second transverse axis, the second axis being mounted so as to slide longitudinally with respect to the supports,
a hinge connecting the rear edge of the front flap to the front edge of the rear flap, the hinge defining a single third transverse rotation axis and being arranged so as to allow a rotation of the flaps upwards, in order to pass them from a covering configuration, in which they are horizontally in line with one another, to a configuration for access to the compartment, in which they are folded one towards the other,
the system wherein:
each end of the second axis is slidably guided by two respective guide rails mounted on each of the supports, the rails extending longitudinally,
the rear end of each of the rails is disposed so that, when the flaps are in the covering configuration and observed in side view, the lower angle defined by a first straight line (D1) connecting the second and third axes and by a second straight line (D2) connecting the first and third axes is less than 180°, so that a force exerted forwards on the second axis effects a rotation of the flaps in order to pass them into the access configuration.

2. The system according to claim 1, wherein the access configuration corresponds to a raising of the flaps by approximately 90° with respect to their position in the covering configuration.

3. The system according to claim 1, wherein the ends of the second axis form laterally projecting fingers, the rails being in the form of slots for receiving the fingers slidably.

4. The system according to claim 1, wherein the front end of the rails is open so as to allow the removal of the ends of the second axis from the rails and a folding of the front flap by a half turn.

5. The system according to claim 1, wherein it further comprises a device for actuating the second axis slidably, the device comprising a drive mounted on a support.

6. The system according to claim 5, wherein the actuation device further comprises a carriage mounted so as to slide longitudinally on the support, one end of the second axis being mounted on the carriage, the drive being mounted so as to actuate the carriage slidably.

7. The system according to claim 6, wherein the actuation device further comprises a worm extending longitudinally, the worm being mounted so as to rotate on the support, the worm passing through a threaded orifice produced in the carriage so as to enable it to be moved when it is actuated for rotation, the rotation being performed by the drive.

8. The system according to claim 6, wherein one end of the second axis mounted on a carriage is mounted removably.

9. The system according to claim 1, wherein the lower faces of the flaps are covered with a verso covering layer, the hinge comprising the portion of the layer extending between the flaps.
